(19) United States
(12) Patent Application Publication
(10) Pub. No.: US 2025/0301017 A1
(43) Pub. Date: Sep. 25, 2025

(54) MACHINE LEARNING BASED CYBER THREAT INTELLIGENCE SYSTEM AND RELATED METHODS

(71) Applicants: THE PENN STATE RESEARCH FOUNDATION, University Park, PA (US); MERIT NETWORK, INC., Ann Arbor, MI (US)

(72) Inventors: John YEN, University Park, PA (US); Michalis KALLITSIS, Ann Arbor, MI (US); Rupesh PRAJAPATI, University Park, PA (US); Vasant HONAVAR, University Park, PA (US); Dinghao WU, University Park, PA (US)

(21) Appl. No.: 19/087,437

(22) Filed: Mar. 21, 2025

Related U.S. Application Data
(60) Provisional application No. 63/569,027, filed on Mar. 22, 2024.

(51) Int. Cl. H04L 9/40; G06N 20/20

(52) U.S. Cl. CPC H04L 63/1491; G06N 20/20; H04L 63/1416

(57) ABSTRACT

Methods and systems for network scanning activity detection are disclosed. The methods and systems include: obtaining darknet data from darknet monitoring sensors; applying the darknet data to a trained machine learning model; obtaining one or more labels of honeypot data corresponding to the darknet data based on the trained machine learning model; and provide a result of threat behaviors of internet protocols based on the one or more labels. Other aspects, embodiments, and features are also claimed and described.

### CROSS-REFERENCE TO RELATED APPLICATION(S)

This application claims priority to U.S. Provisional Patent Application Ser. No. 63/569,027 filed Mar. 22, 2024, the content of which is hereby incorporated by reference in its entirety.

### STATEMENT REGARDING FEDERALLY SPONSORED RESEARCH

This invention was made with government support under Grant Award No. 17STQAC00001 awarded by the Department of Homeland Security. The Government has certain rights in the invention.

### BACKGROUND

The design and structure of cyberattacks continue to evolve. Nefarious actors incessantly scan the Internet, aiming to locate new attack surfaces to be exploited for cyberattacks. Additionally, details of how such scans and/or associated attack attempts are modified by attackers to attempt to circumvent security measures previously put in place.

What are needed is systems and methods to detect and predict such malicious behaviors, including their motives and targets, in a timely manner to take proactive steps and potentially prevent imminent attacks against critical infrastructure.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for network scanning activity detection are disclosed. These methods, systems, and apparatus for network scanning activity detection may include steps or components for: obtaining darknet data from darknet monitoring sensors; applying the darknet data to a trained machine learning model; obtaining one or more labels of honeypot data corresponding to the darknet data based on the trained machine learning model; and providing a result of threat behaviors of internet protocols based on the one or more labels.

In further aspects of the present disclosure, methods, systems, and apparatus for network scanning activity detection training are disclosed. These methods, systems, and apparatus for network scanning activity detection training may include steps or components for: obtaining training darknet data from darknet monitoring sensors; obtaining ground-truth honeypot data; integrating the training darknet data with labels of the ground-truth honeypot data; and training a machine learning model based on the training darknet data and the labels of the ground-truth honeypot data, the labels corresponding to the training darknet data.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for network scanning activity detection according to some embodiments.

FIG. 2 is a flow diagram illustrating an example process for network scanning activity detection according to some embodiments.

FIG. 3 is a flow diagram illustrating an example process for machine learning model training for network scanning activity detection according to some embodiments.

FIG. 4 illustrates a bubble plot showing that an example classifier is able to predict malicious acts from observable behavior captured at darknet according to some embodiments.

FIG. 5 illustrates a graph showing distribution of labels according to some embodiments.

FIG. 6 illustrates a heatmap of label concurrence according to some embodiments.

FIG. 7 illustrates a bubble plot showing the prediction performance of multi-label classification classifier on each label according to some embodiments.

FIG. 8 illustrates an interpretive decision tree for printer crawler according to some embodiments.

FIG. 9 illustrates a bubble plot showing that the labels where the classifier performs poorly according to some embodiments.

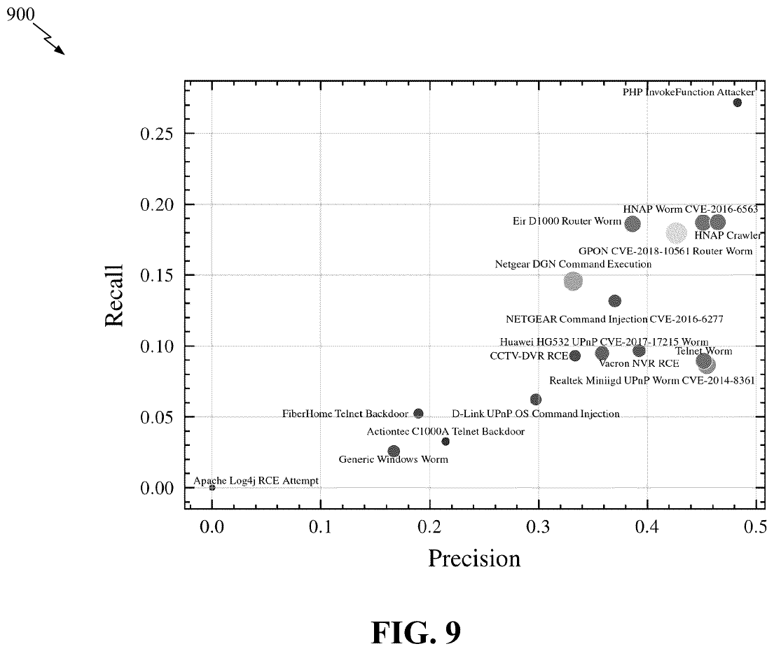

FIG. 10 illustrates plots showing the effect of privileged information on label recognition according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

### Example Network Scanning Activity Detection System

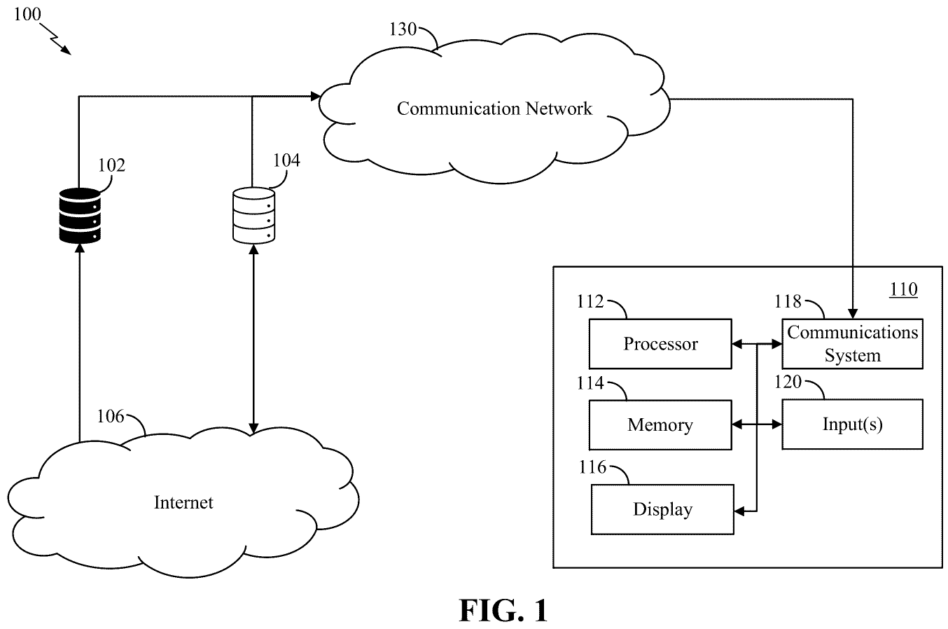

FIG. 1 shows a block diagram illustrating a system for network scanning activity detection according to some embodiments. As shown in FIG. 1, computing device 110 can obtain or receive darknet data from darknet monitoring sensors 102, apply the darknet data to a trained machine learning model, obtain one or more labels of honeypot data corresponding to the darknet data based on the trained machine learning model, and provide a result of threat behaviors of internet protocols based on the one or more labels.

In some examples, computing device 110 can include processor 112. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

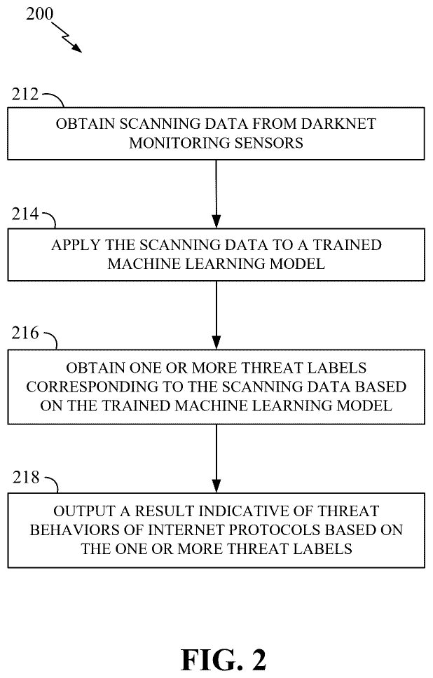

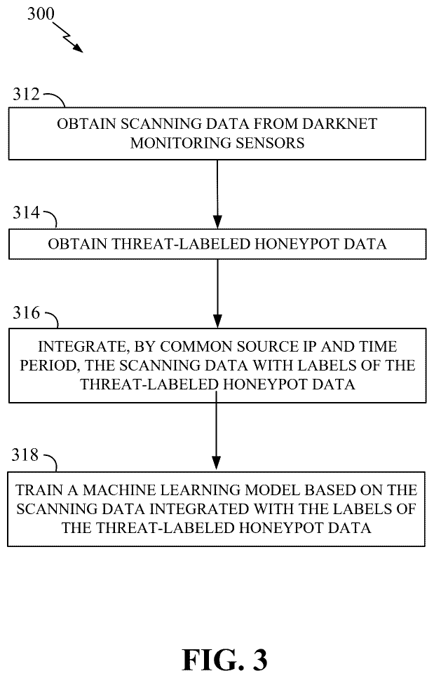

In further examples, computing device 110 can further include a memory 114. The memory 114 can include any suitable storage device or devices that can be used to store suitable data (e.g., darknet data, ground-truth honeypot data, machine learning model, etc.) and instructions that can be used, for example, by the processor 112 to obtain darknet data from darknet monitoring sensors; apply the darknet data to a trained machine learning model; obtain one or more labels of honeypot data corresponding to the darknet data based on the trained machine learning model; provide a result of threat behaviors of internet protocols based on the one or more labels; obtain training darknet data from darknet monitoring sensors; obtain ground-truth honeypot data; integrating the training darknet data with labels of the ground-truth honeypot data; train a machine learning model based on the training darknet data and the labels of the ground-truth honeypot data; and/or generate synthetic darknet data for a subset of the labels. The memory 114 can include any suitable volatile memory, non-volatile memory, storage, or any suitable combination thereof. For example, memory 114 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 112 can execute at least a portion of process 200 or 300 described below in connection with FIG. 2 or 3.

In further examples, computing device 110 can further include communications system 118. Communications system 118 can include any suitable hardware, firmware, and/or software for communicating information over communication network 140 and/or any other suitable communication networks. For example, communications system 118 can include one or more transceivers, one or more communication chips and/or chip sets, etc. In a more particular example, communications system 118 can include hardware, firmware and/or software that can be used to establish a Wi-Fi connection, a Bluetooth connection, a cellular connection, an Ethernet connection, etc.

In further examples, computing device 110 can receive or transmit information (e.g., darknet data from darknet monitoring sensors 102, ground-truth honeypot data from honeypot monitoring sensors 104, a result of threat behaviors of internet protocols to any suitable system, etc.) and/or any other suitable system over a communication network 130. In some examples, the communication network 130 can be any suitable communication network or combination of communication networks. For example, the communication network 130 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 130 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, computing device 110 can further include a display 116 and/or one or more inputs 120. In some embodiments, the display 116 can include any suitable display devices, such as a computer monitor, a touchscreen, a television, an infotainment screen, etc. to display the report or any suitable result of threat behaviors of internet protocols. In further embodiments, the input(s) 120 can include any suitable input devices and/or sensors that can be used to receive user input, such as a keyboard, a mouse, a touchscreen, a microphone, etc.

### Example Process

FIG. 2 is a flow diagram illustrating an example process 200 for network scanning activity detection in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., processor 112 with memory 114) in connection with FIG. 1 can be used to perform example process 200. However, it should be appreciated that any suitable apparatus or means for carrying out the operations or features described below may perform process 200.

At step 212, process 200 can obtain scanning data from darknet monitoring sensors. In some examples, the scanning data includes darknet data and network-based information. For example, the network-based information includes at least one of: a volume of scanning, an intensity indication of scanning, a size of exchanged bytes and packets, or scanned sets of ports. In some examples, process 200 can compile raw data received from darknet monitoring sensors and build the scanning data (e.g., scanning profile about actor(s) in darknet).

In some examples, darknet monitoring sensors 102 collects the scanning data, process 200 can obtain the scanning data. In further examples, the darknet monitoring sensors 102 as intrusion monitoring sensors can include large network telescopes, darknets, Darknet-X, etc. The darknet monitoring sensors 102 passively monitor large numbers (e.g., millions) of unused but routed internet protocol (IP) address spaces. Since these Ip spaces do not host any legitimate user services, any traffic destined to this “dark IP space” is unsolicited and aberrant, usually arising due to malicious activities. Owing to the vast “sensor”, large darknets receive traffic from a plethora of compromised internet-wide hosts, enabling them to observe IPs engaging in new, emerging exploits in a timely manner. The darknet monitoring sensors record information about the frequency and intensity of scanning of an actor, along with the ports and destination hosts targeted by the scanning activity of large number of IPs (e.g., half million IPs or any other suitable number of IPs) that hits the dark IP space on a regular basis (e.g., a daily basis). In further examples, the darknet monitoring sensors extract information, such as time-to-live (TTL), IP identification (IPID) from the packet header that the sensor receives, and/or any other suitable information. In further examples, process 200 can create an exhaustive scanning profile of an actor by aggregating all the observed behaviors over a predetermined time period (e.g., over a day). In some examples, the number of packets, the number of bytes sent by an actor and the inter-arrival time of the packets can be indicators of the intensity and strategy of the scanning actor. In further examples, process 200 can track the ports, protocols, and destination hosts targeted by the attacker to infer the malicious intent of an actor.

However, since darknets are passive and do not collect payload information (e.g., in the case of transmission control protocol (TCP), the TCP handshake is not completed and hence no payload data is recorded). However, as described below, process 200 can generates payload information based on the scanning data, which is passive and network-based information using a machine learning model.

At step 214, process 200 can apply the scanning data to a trained machine learning model. Training a machine learning model for the trained machine learning model is described in connection with process 300 of FIG. 3 below. In some examples, the trained learning model includes a multi-label machine learning model. The multi-label classification machine learning model is a supervised machine learning model, which learns problem, which assigns one or more relevant labels to each instance simultaneously, contrary to traditional single-label classification where only one label is associated with each instance. In some examples, the multi-label classification machine learning model can include a stacked ensemble of a classifier chains model, a binary relevance classifier model, and a label powerset classifier model. In further examples, the stacked ensemble is constructed with sparsity regularization.

In some examples, the multi-label learning tasks can be solved using problem transformation and algorithm adaptation. Like the name suggests, problem transformation algorithms decompose a multi-label classification task into a series of single-label classification problems or label ranking tasks where each single-label problem focuses on one label of the multi-label set. Algorithm adaptation techniques adapt and extend the existing machine learning algorithms to solve the multi-label problems directly. Like in traditional single label classifications, ensemble methods can be a popular choice for multi-label classification because of the inherent ability to handle label correlations and the robust performance.

Binary Relevance (BR) is an example problem transformation approach which transforms a multi-label classification into a series of binary classification problems. Classifier Chains (CC) chains such single-label classifiers in a way that can model label correlations. Classifier chains structurally models the dependencies between the labels to effectively improve on BR. CC leverages a chaining mechanism that links a series of binary base classifiers C₁, . . . , Cⱼ in such a manner that each classifier Cₖ learns the binary association of label λₖ not only from the current feature space, but also from the predictions of all other classifiers C₁, . . . , Cₖ₋₁ that that precede the classifier in the chain. This ordering of base classifiers in chaining fashion can, thus, model label correlations effectively while maintaining achievable computational complexity. However, it should be appreciated that the base classifier can be any binary classifier such as Support Vector Classifiers (SVC), Logistic Regression Classifier (LRC) and Naive Bayes Classifier (NBC).

Contrary to other multi-label classification algorithms which devise special treatments to handle multiple labels, Label Powerset (LP) methods can transform multi-label classification to a single-label classification task by treating multi-label data as a single-label dataset, where each unique combination of labels is considered a single class. However, the performance of such an approach can suffer when there is an inadequate number of examples to learn a particular label combination from. This situation is normally the case with most MLDs where there is an abundance of non-repeating label sets. In order to address this issue, RAndom k-labELsets (RAKEL) algorithm can break the set of labels into a number of random smaller subsets and constructs an ensemble of single label classifiers where each of these classifiers learn only on a particular subset of labels, thus, mitigating the problem of insufficient instances per label as the subset has limited number of labels. Label correlations are also inherently addressed by assembling multiple single label classifiers that learn on different label subsets. In the implementation of RAKEL, the label space can be divided into equal partitions of size k, train an LP classifier for each partition and make predictions by assembling the result of all trained classifiers. The value of k and base classifier is chosen through hyperparameter tuning.

Ensemble approaches can show superior performances in the multi-label classification problems; the classifier chain and RAKEL described above are both ensemble methods. While such bagging based ensemble models are common in practice, in this research, a Multi-Label Weighted Stacked Ensemble (MLWSE) approach can be implemented, where the approach learns the weights of ensemble members and exploits label correlations simultaneously. A stacked ensemble of CC, BR classifier and LP classifier can be constructed with sparsity regularization, and the weights of the ensemble members are determined by pairwise label correlations. The optimization algorithm based on accelerated proximal gradient and block coordinate descent techniques can achieves the optimal ensemble member combination and weights.

When the universe of all possible labels is extremely large, the approaches described above may fail to find relevant labels with high precision. Though the dataset used for this disclosure does not fit the problem of extreme labels perfectly, two state-of-the-art XMC methods, namely NapkinXC and ProXML are used, because it is desirable to verify that these approaches are equally competent in predicting relevant labels as the pool of labels in this proposed framework will eventually become extremely large with the growth of vulnerabilities, malware and changing behaviors. NapkinXC is an extremely fast approach to extreme multi-label classification, which is based on probabilistic label trees (PLTs). Likewise, ProXML is a robust optimization framework especially designed for achieving better tail label prediction when the pool of labels is extremely high.

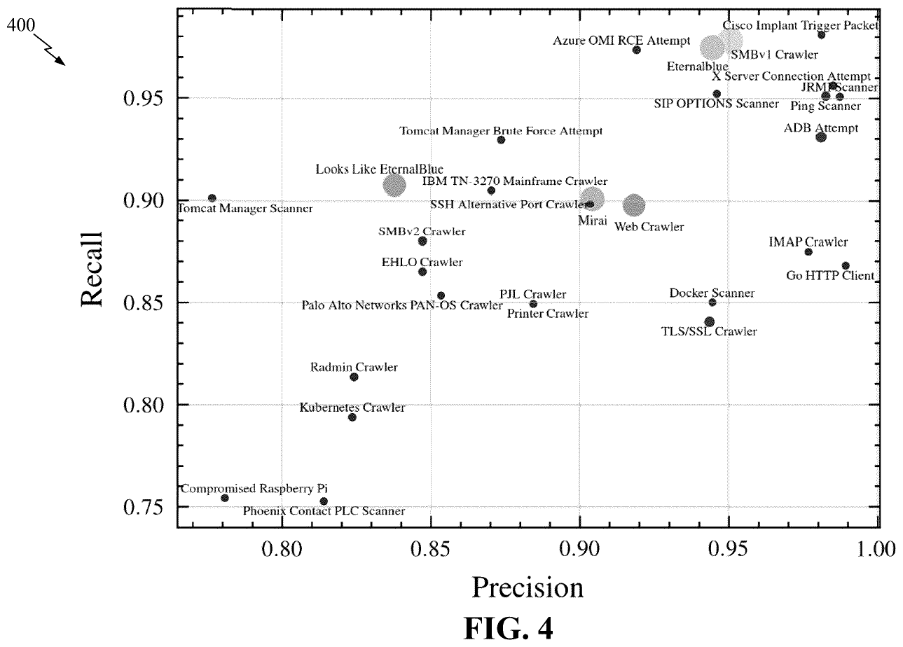

At step 216, process 200 can obtain one or more threat labels corresponding to the scanning data based on the trained machine learning model. In some examples, the one or more threat labels include payload-based information and may obtained from the Honeypot model. For example, the payload-based information includes at least one of: a scan label set, an exploit label set, a malware label set, a brute-force label set, a tool label set. Thus, although scanning data is passive information, the trained machine learning model generates reactive and bidirectional communication information, which is honeypot data, based on the darknet data. In some examples, the one or more threat labels annotate the threat characteristics of a malicious actor. Thus, the one or more threat labels summarize the vulnerability checks and exploits, disseminated malware/worms, authentication attempts, scanning tools, programming libraries, search engines, crawlers, etc. associated with a specific scanning activity. The stacked ensemble with which the inventors experimented outperformed the other classifiers across 10 metrics and has comparable performances on the rest of the metrics. The ensemble performed extremely well on 35 out 83 total labels in the dataset which correspond to 53,497 IPs (˜90%) of the total 59,500 IPs that the inventors tested on. The ensemble achieved high prediction accuracy and low false positive (i.e., both precision and recall were greater than 0.8) on varieties of labels that represent crawlers, remote code execution exploits, malware/worms, and brute force authentication attempts as shown in FIG. 4. FIG. 4 shows a bubble plot. The bubble plot shows the ensemble is able to predict crawlers, vulnerability exploits, malware and brute force authentication attempts with high precision and recall, solely from the observable behavior captured at darknet. The size of the bubbles represents the frequency of the label in dataset.

In some examples, the one or more labels of honeypot data can include at least one of: scan data (hosts performing port or vulnerability scans), exploit data (bosts attempting to exploit known vulnerabilities), malware data (hosts trying to propagate malware codes/worms), brute-force data (hosts making brute force authentication attempts), or tool data (scanning tools used by the hosts). The scan data can include at least one of: SMBv1 Crawler, Web Crawler, TLS/SSL Crawler, Ping Scanner, ADB Check, CGI Script Scanner, SMBv2 Crawler, HNAP Crawler, Radmin Crawler, Follows HTTP Redirects, Carries HTTP Referer, EHLO Crawler, Tomcat Manager Scanner, RDP Crawler, Kubernetes Crawler, SSH Alternative Port Crawler, or Tridium NiagraAX Fox ICS Scanner. The exploit data can include at least one of: Externalblue, Looks Like EternalBlue, JAWS Webserver RCE, Netgear DGN Command Execution, Azure OMI RCE Attempt, NETGEAR Command Injection CVE-2016-6277, Vacron CVR RCE, CCTV_DVR RCE, D-Link UPnP OS Command Injection, or PHP InvokeFunction Attacker. The malware data can include at least one of Mirai, ADB Attempt, GPON CVE-2018-10561 Router Worm, Linksys E-Series The Moon Worm, Realtek Miniigd UPnP Worm CVE-2014-8361, Eir D1000 Router Worm, HNAP Worm CVE-2016-6563, Telnet Worm, Zyxel Router Worm, Looks Like Conficker, Huawei HG532 UPnP CVE-2017-17215 Worm, SSH Worm, Generic Windows Worm, Looks Like RDP Worm, Hadoop Yarn Worm, or PHPMyAdmin Worm. The brute-force data can include at least one of: Telnet Bruteforcer, Generic IoT Brute Force Attempt, SSH Bruteforcer, X Server Connection Attempt, Tomcat Manager Brute Force Attempt, MSSQL Bruteforcer, Shenzhen TVT Bruteforcer, FiberHome Telnet Backdoor, or Actiontec C1000A Telnet Backdoor. The tool data can include at least one of: ZMap Client, Python Requests Client, Metasploit, Cobalt Strike SSH Client, GoHTTP Client, or Nmap. It should be appreciated that the groups (scan data, exploit data, malware data, brute-force data, or tool data) of data as the labels are a mere example. Any other suitable group of data can be added as a label. Further, it should be appreciated that the specific labels listed above are mere examples and any other suitable labels can be added.

At step 218, process 200 can output a result indicative of threat behaviors of internet protocols based on the one or more threat labels. In some examples, the result can include risks posed by different actors based on the one or more labels and provide countermeasures. In further examples, the result can include entire characteristics of each actor based on the one or more labels. Thus, process 200 can provide payload based information based on the passive darknet data without operational and maintenance costs for deploying honeypots. The payload based information can be further analyzed to gain insights into the attacker's motives, mechanisms and targeted services. Further, process 200 can provide the result of threat behaviors of internet protocols, which is based on payload based information, without any delay unlike real honeypot data, which is produced with a delay of a few hours or even days compared to the darknet data. In further examples, the result of threat behaviors of internet protocols can include whether each internet protocol (actor) is benign or malicious. Thus, process 200 leverages the vast observability afforded by large network telescopes to enhance the threat intelligence gathered by reactive honeypot sensors. Specifically, the data collected by a darknet with a large “aperture” is integrated with data from honey pots equipped with rich, annotated labels. By coupling these two datasets, process 200 harnesses the benefits offered by both types of sensors. On one end, the detailed threat insights distilled from honeypot sensors provide a microscopic view of the threat behaviors captured and on the other end, the vast IP coverage offered by large telescopes allows one to amplify/enhance the behavior-based threat knowledge to a large number of actors, thus providing a macroscopic perspective into the trend of malicious activities.

### Example Process

FIG. 3 is a flow diagram illustrating an example process 300 for network scanning activity detection training in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., processor 112 with memory 114) in connection with FIG. 1 can be used to perform example process 300. However, it should be appreciated that any suitable apparatus or means for carrying out the operations or features described below may perform process 300.

At step 312, process 300 can obtain scanning data from darknet monitoring sensors. In some examples, the scanning data is substantially similar to the scanning data at step 212 of FIG. 2.

At step 314, process 300 can obtain threat-labeled honeypot data. In some examples, the threat-labeled honeypot data can be collected from honeypot sensors (e.g., Greynoise sensors (GN-Net)). In some examples, the honeypot sensors can collect and meticulously labels data about the scanners the sensors observe. As described above, the amount of honeypot data that the honeypot sensors produce is smaller than the amount of darknet data that the darknet monitoring sensors produce. In addition, due to interactive and bidirectional communication abilities in the honeypot sensors, the honeypot data is produced with a delay of a few hours or even days compared with when a large darknet would capture the same activities. In some examples, the honeypot sensors assign a set of labels to each IP actor that hit its sensors by utilizing an internal, proprietary (and unknown to users) labeling methodology. The labels annotate the patterns of the observed malicious activity such as vulnerability checks and exploits, tools used for probin, penetration and exploitation strategies, propagated malware/worms, and the intent of the actors. Since these labels describe different aspects of the threat actors, usually more than one label is simultaneously assigned to comprehensively describe the actions and intent. The honeypot sensors harness pay-load-based information and curate the labels.

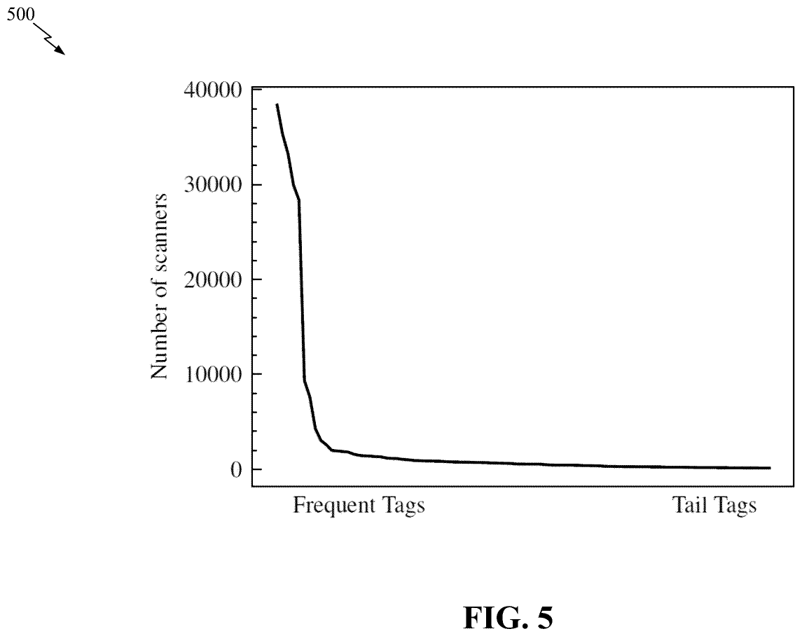

In further examples, process 300 can further generate synthetic darknet data for a subset of the labels, a subset of training darknet data corresponding to the subset of the labels being less than another subset of training darknet data corresponding to another subset of the labels. In some examples, the synthetic darknet data can be generated based on interpolation between neighboring instances in the subset of the training darknet data. In some examples, when trained on multi-label datasets with high concurrency among the majority and minority labels, classifier models tend to be biased towards the majority labels and perform poorly on minority labels. As shown in FIG. 5, darknet-honeypot multi-label dataset exhibits the biased pattern where the IP addresses associated with the most frequent labels are in tens of thousands whereas the tail labels or the minority labels are represented by only a few hundred sources. Thus, process generates the synthetic darknet data for the minority labels (e.g., the median frequency of labels in the darknet data).

In some examples, an oversample technique (e.g., a multi-label synthetic minority over-sampling technique) can be used to generate the synthetic darknet data for the minority labels to balance the darknet data. For example, the oversampling technique synthetically generates instances for minority labels. In some examples, IRLbl metric can be used to identify the minority labels, and synthetic samples can be produced for the labels by interpolating values from the neighboring samples that lie close together on the data space. Process 300 can designate all those underrepresented labels that appear less than the median frequency of labels in the multi-label dataset as minority labels and augment the dataset with a total of 50,000 synthetic samples generated for all minority samples. This augmentation drastically reduced the unevenness in the distribution of labels while only increasing the label concurrence by a small amount, as shown in Table 1 below. The mean imbalance ratio per label significantly dropped from 101.77 to 15.14 whereas the SCUMBLE (Score of Concurrence among iMBalanced labEls) score increased slightly from 0.12 to 0.15. It should be appreciated that any other suitable technique to balance the darknet data can be used. For example, resample, algorithm adaptation, and/or ensemble methods can be used to address the label imbalance issue. In some examples, the SCUMBLE score of a multi-label dataset

TABLE 1
Comparison of imbalance level before and after oversampling

| | | Original |
|---|---|---|
| | Original | Data + Synthetic |
| Measures | Data | Instances |
| No. of instances | 95637 | 145637 |
| Label Cardinality | 2.52 | 5323 |
| MeanIR | 101.77 | 15.14 |
| SCUMBLE | 0.12 | 0.15 |

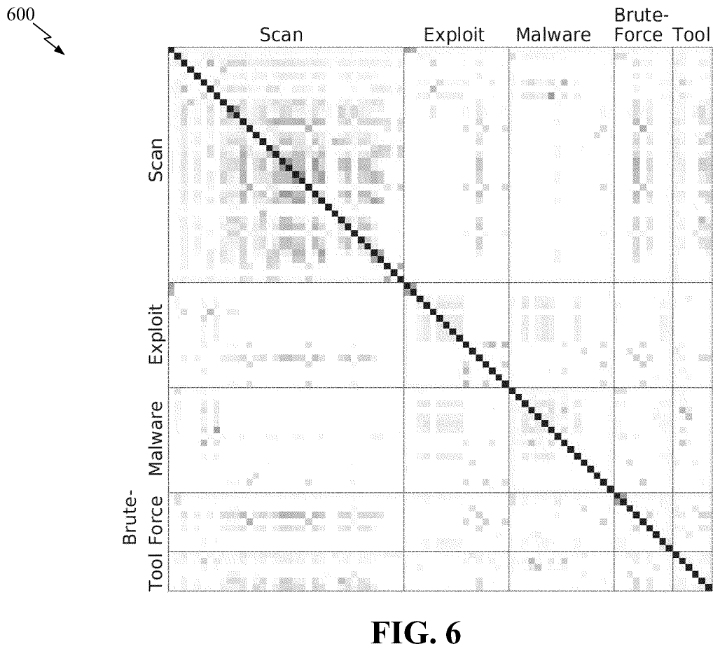

The heatmap of label concurrent in FIG. 6 shows that while there is potential of two or more labels appearing together, the concurrence is common among labels of same frequency and less among the majority and minority labels. In FIG. 6, each row/column represents a label, shown in the same order as in Table 2. Darker (more saturated) colors indicate high degree of concurrence.

TABLE 2
Honeypot-based Labels and their Groups

| | |
|---|---|
| Labels | Frequency |

Scan

| | |
|---|---|
| SMBv1 Crawler | 38389 |
| Web Crawler | 28369 |
| TLS/SSL Crawler | 3032 |
| Ping Scanner | 1807 |
| ADB Check | 1409 |
| CGI Script Scanner | 1380 |
| SMBv2 Crawler | 1304 |
| HNAP Crawler | 1132 |
| Radmin Crawler | 1031 |
| Follows HTTP Redirects | 871 |
| Carries HTTP Referer | 869 |
| EHLO Crawler | 765 |
| Tomcat Manager Scanner | 739 |
| RDP Crawler | 665 |
| Kubernetes Crawler | 633 |
| SSH Alternative Port Crawler | 549 |
| Tridium NiagraAX Fox ICS Scanner | 535 |

Exploit

| | |
|---|---|
| Eternalblue | 35309 |
| Looks Like EternalBlue | 29948 |
| JAWS Webserver RCE | 1924 |
| Netgear DGN Command Execution | 1461 |
| Azure OMI RCE Attempt | 903 |
| NETGEAR Command Injection | 741 |
| CVE-2016-6277 | |
| Vacron NVR RCE | 707 |
| CCTV-DVR RCE | 617 |
| D-Link UPnP OS Command Injection | 592 |
| PHP InvokeFunction Attacker | 380 |

Malware

| | |
|---|---|
| Mirai | 33245 |
| ADB Attempt | 4269 |
| GPON CVE-2018-10561 Router Worm | 1865 |
| Linksys E-Series TheMoon Worm | 1583 |
| Realtek Miniigd UPnP Worm | 1331 |
| CVE-2014-8361 | |
| Eir D1000 Router Worm | 1178 |
| HNAP Worm CVE-2016-6563 | 1118 |
| Telnet Worm | 993 |
| Zyxel Router Worm | 926 |
| Looks Like Conficker | 840 |
| Huawei HG532 UPnP | 792 |
| CVE-2017-17215 Worm | |
| SSH Worm | 759 |
| Generic Windows Worm | 652 |
| Looks Like RDP Worm | 284 |
| Hadoop Yarn Worm | 266 |
| PHPMyAdmin Worm | 200 |

Brute-Force

| | |
|---|---|
| Telnet Bruteforcer | 9330 |
| Generic IoT Brute Force Attempt | 7584 |
| SSH Bruteforcer | 845 |
| X Server Connection Attempt | 688 |
| Tomcat Manager Brute Force Attempt | 542 |
| MSSQL Bruteforcer | 532 |
| Shenzhen TVT Bruteforcer | 443 |
| FiberHome Telnet Backdoor | 421 |
| Actiontec C1000A Telnet Backdoor | 265 |

Tool

| | |
|---|---|
| ZMap Client | 2580 |
| Python Requests Client | 1981 |
| Metasploit | 713 |
| Cobalt Strike SSH Client | 387 |
| Go HTTP Client | 364 |
| Nmap | 256 |

At step 316, process 300 can integrate, by common source IP and time periods, the scanning data with labels of the threat-labeled honeypot data. For example, the labels of the threat-labeled honeypot data can include one or more label of the list under Table 3 above. In some examples, integrating the training darknet data with the labels can indicate mapping labels of the threat-labeled honeypot data into the training darknet data. This integration or mapping process can be performed manually or automatically. In some examples, the integration of Honeypot data and Darknet data can be based on common source IP (in the two datasets) for a common time interval.

At step 318, process 300 can train a machine learning model based on the training darknet data integrated with the labels of the threat-labeled honeypot data. For example, process 300 can build and evaluate a machine learning model to predict threat labels from Honeypot data using scanning patterns from Darknet. In some examples, process 300 can train the machine learning model further based on the synthetic darknet data. In some examples, the machine learning model can learn the threat-labeled honeypot data by using only the network-based features of darknet data such as volume and intensity of scanning, size of exchanged bytes and packets, scanned sets of ports, etc. During the training of the machine learning model, process 300 can map the training darknet data to labels of the threat-labeled honeypot data. For example, the machine learning can map features obtained from the one-way traffic (i.e., darknet data) captures by darknet monitoring sensors (e.g., Darknet-X) to the distilled labels assigned by honeypot sensors (e.g., GN-Net) as a supervised multi-label classification problem. Thus, the machine learning model can learn the inherent association predict one or more GN-Net labels for IPs in darknet data as input. The mapping can be learned on a set of scanning IPs which are commonly observed by both data sources (darknet scanning data and threat-labeled honeypot data). In some examples, the machine learning model may not use source IP as features. Thus, the machine learning model can be applied to other Darknet data whose source IP does not occur in the Honeypot data.

The inventors' determined that there exists an association between the data recorded for these common IPs, which holds as long as the IP represents the same device and same behavior when observed across these different sensors. The dynamic nature of IP assignment and the changing behavior of malicious actors pose a particular challenge to this assumption. Hence, the inventors take a short-time window Δt=1 day during which a system/process can safely assume that an IP observed on the darknet data and honeypot data refers to the same scanning device functioning with the same threat characteristic. A day-length window can be used as plausible time period for IP address-device stability.

Let, S_{D} and S_{H} denote the set of IPs observed in D (darknet data) and H (honeypot data) within Δt, respectively (where |S_{D}|>>|S_{H}| and |·| denotes the set cardinality). Then, S_{C}:=S_{D}∩S_{D} is the set of all IPs observed by both sources during Δt. For the i^{th} IP in this set, S_{C}, including a total of n IPs, H's label generating function G produces a set of labels Yᵢ⊆L, where i=1, 2, . . . , n and L is the set of all pre-defined labels. This i^{th} IP is profiled using a high dimensional feature vector x_{D}_{ᵢ}∈ [symbol] ^{P} constructed from the network-based features captured by D. A rich, low dimensional representation xᵢ∈ [symbol] ^{Q} (where Q<<P) of the feature vector x_{D}_{ᵢ} is learned by employing the autoencoder architecture. The embedded feature vector xᵢ along with the labels Yᵢ constitute the i^{th} instance in the multi-label data M=(xᵢ, Yᵢ), i=1, . . . , n which consists of a total n=|M| multi-label instances, one for each IP in S_{C}.

In some examples, the trained machine learning model can include a multi-label classification machine learning model. The multi-label classification machine learning model is a supervised machine learning model, which learns problem, which assigns one or more relevant labels to each instance simultaneously, contrary to traditional single-label classification where only one label is associated with each instance. In some examples, the multi-label classification machine learning model is an ensemble system including individual learners or base components, which are termed as base classifiers. Given a set of training examples, Mₜᵣₐᵢₙ=(xᵢ, Yᵢ),i=1, . . . nₜᵣₐᵢₙ where nₜᵣₐᵢₙ is the size of training set, multi-label learning finds a function F(x) that maps each attribute vector xᵢ to its associated sets of labels Yᵢ, as given by: F(xᵢ)=Ŷᵢ, where Ŷᵢ⊆L is the set of predicted labels.

The machine learning model can be constructed or otherwise trained based on training data using one or more different learning techniques, such as supervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the machine learning algorithm is configured to learn a general rule or model that maps the inputs to the outputs based on the provided example input-output pairs.

Different types of machine learning algorithms can have different network architectures (e.g., number of layers, type of layers, ordering of layers, connections between layers, hyperparameters for layers). In some configurations, neural networks can be structured as a single-layer perceptron network, in which a single layer of output nodes is used and inputs are fed directly to the outputs by a series of weights. In other configurations, neural networks can be structured as multilayer perceptron networks, in which the inputs are fed to one or more hidden layers before connecting to the output layer.

As one example, a machine learning algorithm can be configured as a feedforward network, in which the connections between nodes do not form any loops in the network. As another example, a machine learning algorithm can be configured as a recurrent neural network (“RNN”), in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (“LSTM”) networks, networks based on or using gated recurrent units (“GRUs”), or the like.

A machine learning algorithms can be structured with different connections between layers. In some instances, the layers are fully connected, in which each all of the inputs in one layer are connected to each of the outputs of the previous layer. Additionally or alternatively, neural networks can be structured with trimmed connectivity between some or all layers, such as by using skip connections, dropouts, or the like. In skip connections, the output from one layer jumps forward two or more layers in addition to, or in lieu of, being input to the next layer in the network. An example class of neural networks that implement skip connections are residual neural networks, such as ResNet. In a dropout layer, nodes are randomly dropped out (e.g., by not passing their output on to the next layer) according to a predetermined dropout rate. In some embodiments, a machine learning algorithm can be configured as a convolutional neural network (“CNN”), in which the network architecture includes one or more convolutional layers. In some embodiments, process 200 can use tensor flow lite to deploy the machine learning algorithm to a mobile device. In further embodiment, teachable machine can be used for training model. In further examples, a neural engine on the mobile device can perform the machine learning operation. In even further examples, process 200 can provide ground truth of any plant bioactivity and allow on-board image processing in the mobile device (e.g., by using the temporal speckle contrast algorithm).

### Example Embodiments and Validation Experiments

A multi-label dataset can be generated from the aggregated feature profiles from darknet sensors (e.g., Darknet-X) as the input features and annotated labels (e.g., the GreyNoise sensor's (GN-Net) annotated labels) as the ground-truth classes. An autoencoder learns and generates 50-dimensional embeddings for the input feature vectors that retain the information contained in the original data. An optimal autoencoder architecture can be identified and replicated to provide a rich and meaningful representation of scanning profile data that can be encoded in a latent space of just 50 dimensions without significant loss of information. The embeddings and labels can be formatted to meet the input data format expected by each model. However, for some general purpose programing language (e.g., ProXML), which expects indices of labels, the labels are encoded using a multi-label binarizer. The identification of the minority labels in the MLD can generate about 50,000 (50K) synthetic samples by oversampling the identified minority labels (e.g., using MLSMOTE algorithm). The augmented data is used for the rest of the experiments.

Each model examined in the experiment has its own individual sets of hyperparameters that can be tuned. The performance of Classifier Chain (CC) algorithm can be determined primarily by the base classifier and by the order of the single label classifiers in the chain. In the experiment the inventors performed, an internal 5-fold cross validation on the training set can be used, namely, Support Vector Classifier (SVC), Naive Bayes Classifier (NBC) and Logistic Regression Classifier (LRC). The results obtained via cross-validation shows that LRC outperforms the other two as base classifier for CC.

In the experiment, the label subset size (k), number of models and threshold for the output can be set before training the Random k-labelsets (RAKEL) algorithm. In the experiment, the subset size is set to 3 which is shown to achieve best results in most Multi-Label classification (MLC) domains. The number of models is determined by dividing the total number of labels by the subset size. For example, in the experiment, the number of models is 30 and the threshold for the final output is set to 0.5. Accordingly, Multi Label k Nearest Neighbors (MLKNN) outperformed LRC and SVC in the 5-fold internal cross-validation for RAKEL on the training set.

For the Multi-Label Weighted Stacked Ensemble (MLWSE) model, a stacked ensemble of three multi-label classifiers was built, namely, Binary Relevance (BR), Classifier Chain (CC) and Label Powerset (LP), where the weights are learned during the training process. The SVC is used as a base classifier for BR model, and LRC and MLkNN are used as the base classifiers for CC and LP respectively as determined from aforementioned hyperparameter tuning.

The desirable parameter decision for NapkinXC is the selection of the solver for large-scale regularized classification. A library of linear solvers (e.g., liblinearSolver, liblinearC, and liblinearEps) from which liblinearSolver was selected as the base optimizer, can be used. For ProXML, a performance model can be implemented. Experiments with 10-fold cross-validation were executed with different seeds for training and evaluation of each model. The evaluation results presented below are averaged over these runs. The best performing model among the above-mentioned group of approaches is selected (e.g., one that outperforms the rest on majority of the evaluation metrics described above). Additionally, there can be trade-offs between performance and complexity in terms of training and inference time, and resource consumption to be considered while choosing the model for application to real world threat inference.

After determining the best performing model based on the built dataset, predictive abilities of the performing model can be determined. For example, the validation of forecasting abilities of the model based on different and multiple datasets can be determined upon model training based on a pre-determined period (e.g., every other month) unless new labels have been added. The test data set for a predetermined period can be built based on the steps described herein.

Among the Internet Protocols (IPs) that were observed on the Darknet-X on Day i of Month Z but were only captured and annotated by GN-Net's sensors on Day i+1 on the same month Z are selected so that the IP is considered only once. For example, if Darknet-X observes the IP on Day i and Day j (where j>i), only the first observation from Day i is included in the dataset.

For each IP selected above, a row in the test dataset is created where latent space embeddings of scanning profile recorded by Darknet-X in Day i form the input features and the labels generated by GN-Net on Day i+1, which becomes the corresponding ground-truth labels for that instance.

The rationale behind this 1-day sliding window approach for building test datasets is based on the assumption that the same IP address observed at any source within a given time window can be attributed to the same actor. The selected model can be tested on the test datasets where the input features are fed into the model and its label predictions are compared with the corresponding ground truth labels. The corresponding ground truth labels are labels that are annotated on the following day when the honeypot actually observed the IP. Accordingly, the threat forecasting abilities of the model can be assessed based on an evaluation metrics discussed in detail somewhere below.

The ability of Darknet-X to observe IPs earlier than other sources because of its larger aperture is one of the rationales behind this experiment. For example, the earlier a threat actor is observed, the earlier a prediction can be made about its threat behaviors from its scanning profile. In the experiment, exploratory analysis to determine how early the Darknet-X observes threat actors in comparison to GN-Net was determined. In order to determine this relative latency, only the fresh IPs are considered (i.e., the IPs that are observed by both the sensors for the very first time during a particular month Z). The difference (in days) of the first appearance dates of these fresh IPs on these sensor networks is determined and averaged to get an estimate of how much in advance can this proposed framework inform analysts about security threats. Furthermore, the relative latency evolution was conducted between two consecutive months (e.g., June and July) for this experiment.

### Evaluation

The output of a multi-label classifier is a set of labels unlike a single label in a traditional single label classification. The evaluation metrics that assess the performance of the classifiers may consider partial correctness of the predicted labels. As such, the metrics used to evaluate traditional single label classification cannot be directly used to assess multi-label classifiers. Commonly used evaluation metrics for assessing the performance of MLCs can be grouped into three categories, namely, Example-based measures, Label-based measures, and Ranking-based measures.

TABLE 3
Comparison of micro-metrics

| | Classifier | | | | |
|---|---|---|---|---|---|
| Metrics | Chain | MLWSE | RAKEL | NapkinXC | PROXML |
| Precision | 0.88 | 0.90 | 0.87 | 0.88 | 0.87 |
| Recall | 0.80 | 0.78 | 0.81 | 0.78 | 0.76 |
| F1-score | 0.84 | 0.84 | 0.84 | 0.83 | 0.81 |

The Label-based metric include a precision, recall, and f1-scores, which are first calculated for each individual labels and aggregated over all the labels using different averaging operation, namely, micro, macro, and weighted metrics. As shown in Table 3 above, micro-averaged measures (e.g., micro-evaluation metric) aggregate the contributions of all labels to compute the final average precision, recall and f1-score. The MLWSE has a slightly higher micro-averaged precision compared to its counterparts.

TABLE 4
Comparison of macro-metrics

| | Classifier | | | | |
|---|---|---|---|---|---|
| Metrics | Chain | MLWSE | RAKEL | NapkinXC | PROXML |
| Precision | 0.70 | 0.68 | 0.67 | 0.68 | 0.62 |
| Recall | 0.53 | 0.51 | 0.53 | 0.46 | 0.41 |
| F1-score | 0.60 | 0.58 | 0.59 | 0.55 | 0.49 |

As shown in Table 4 above, the macro-evaluation metric (e.g., precision, recall, and f1-score) shows that the CC outperforms more complex approaches across all 3 macro-averaged metrics which indicates that CC has better performance across all labels which is in accordance with the design where base classifiers that each learn a label are chained in orderly fashion.

TABLE 5
Comparison of weighted-metrics

| | Classifier | | | | |
|---|---|---|---|---|---|
| ee | Chain | MLWSE | RAKEL | NapkinXC | PROXML |
| Precision | 0.85 | 0.85 | 0.84 | 0.83 | 0.83 |
| Recall | 0.80 | 0.78 | 0.81 | 0.78 | 0.76 |
| F1-score | 0.81 | 0.79 | 0.81 | 0.78 | 0.79 |

As shown in Table 5 above, the compared models herein achieve competitive performance in terms of weighted metrics. For example, the CC and MLWSE have a slight edge in terms of precision, whereas RAKEL have a slight edge in terms of recall.

TABLE 6
Comparison of Loss metrics

| | Classifier | | | | |
|---|---|---|---|---|---|
| Metrics | Chain | MLWSE | RAKEL | NapkinXC | PROXML |
| Hamming | 0.0094 | 0.0091 | 0.0094 | 0.0099 | 0.0092 |
| Loss | | | | | |
| Label | 0.14 | 0.15 | 0.13 | 0.15 | 0.13 |
| Ranking | | | | | |
| Loss | | | | | |
| Coverage | 20.32 | 21.24 | 20.58 | 21.07 | 20.66 |
| Loss | | | | | |
| One Error | 0.056 | 0.044 | 0.057 | 0.057 | 0.051 |

As shown in Table 6 above, the MLWSE have a lower hamming loss and a significantly smaller One error. Furthermore, the MLWSE model surpasses the rest of the model in the Precision @k (where k=1,3, or 5) and normalized discounted cumulative gain (nDCG) @k (where k=1,3, or 5) metrics as shown in Table 7 and 8 respectively. Accordingly, MLWSE transcends other models in 10 out of 19 evaluated measures, MLWSE classifier model was elected to be used in the rest of the evaluation.

TABLE 7
Comparison of Precision @k (where k = 1, 3, or 5)

| | Classifier | | | | |
|---|---|---|---|---|---|
| Metrics | Chain | MLWSE | RAKEL | NapkinXC | PROXML |
| Precision@1 | 0.946 | 0.954 | 0.951 | 0.936 | 0.933 |
| Precision@3 | 0.659 | 0.669 | 0.660 | 0.662 | 0.650 |
| Precision@5 | 0.432 | 0.443 | 0.441 | 0.440 | 0.438 |

TABLE 8
Comparison of nDCG @k (k = 1, 3, or 5)

| | Classifier | | | | |
|---|---|---|---|---|---|
| Metrics | Chain | MLWSE | RAKEL | NapkinXC | PROXML |
| nDCG@1 | 0.773 | 0.786 | 0.770 | 0.752 | 0.767 |
| nDCG@3 | 0.558 | 0.559 | 0.571 | 0.562 | 0.561 |
| nDCG@5 | 0.381 | 0.391 | 0.388 | 0.389 | 0.378 |

As mentioned above, the MLWSE model elected to be used in the rest of the evaluation. The evaluation on micro-metric, macro-metric, and weighted-metric for a three consecutive month (e.g., July, August, and September) was conducted for analyzing precision, recall, and f1-scores. Referring to Tables, 9, 10, and 11, the tables show similar precision, recall, and f1-scores across the three different test sets which are very close to the scores that this model obtained in a previous dataset on which it was trained.

TABLE 9
Comparison of micro-metrics

| Metrics | June | July | August |
|---|---|---|---|
| Precision | 0.72 | 0.69 | 0.71 |
| Recall | 0.85 | 0.86 | 0.85 |
| F1 Score | 0.78 | 0.77 | 0.75 |

TABLE 10
Comparison of macro-metrics

| Metrics | June | July | August |
|---|---|---|---|
| Precision | 0.67 | 0.63 | 0.65 |
| Recall | 0.51 | 0.51 | 0.49 |
| F1 Score | 0.58 | 0.56 | 0.56 |

TABLE 11
Comparison of weighted-metrics

| Metrics | June | July | August |
|---|---|---|---|
| Precision | 0.81 | 0.80 | 0.78 |
| Recall | 0.77 | 0.76 | 0.77 |
| F1 Score | 0.79 | 0.78 | 0.77 |

TABLE 12
Comparison of loss metrics

| Metrics | June | July | August |
|---|---|---|---|
| Hammering Loss | 0.0092 | 0.0094 | 0.0091 |
| Label Ranking Loss | 0.13 | 0.14 | 0.15 |
| Coverage Loss | 20.55 | 20.32 | 21.24 |
| One Error | 0.045 | 0.056 | 0.044 |

Additionally, the loss values shown in Table 12 does not deviate much from the loss values observed in the previous datasets. The replicated performance of the model across these 3 test datasets derived for 3 different months shows the model is capable in forecasting threat behaviors with high precision without having to re-train the model repeatedly.

In order to evaluate the relative latency, a comparison between the month of June and July was made by comparing the relative latency in IP observation by GN-net with respect to Darknet-X. The IPs observed by both these sources during the month of June 14,158 were completely new IPs that had never been observed by both sensors before June. This number of fresh IPs for the month of July was 47,479. On average, Darknet-X observed IPs 1.32 days earlier than GN-Net during June and 1.29 days earlier during July. Thus, it is safe to conclude that, on average, Darknet-X observes at least a day earlier than GN-Net.

In the experiment, association between what large darknets observe and what other sensors (e.g., honeypot) observe and association of how to enhance behavior-based threat intelligence by combining data sources effectively is evaluated. Most packets arriving at network telescopes include malicious activities such as botnet scanning and worm propagation, and general attack trends by analyzing such activities. However, it is difficult to identify the intents of each scan and specific vulnerabilities they may seek at the application level because darknets only observe the initial connection attempts and lack any packet payload. Conventionally, many applications are not hosted at their traditional IANA-assigned ports, thus, inferring which vulnerability is sought by nefarious actors merely by inspecting network-level features obtained from darknets (e.g., port information) is challenging. This gap can be filled by leveraging honeypot data and/or by coupling the two sources together to enhance behavior-level threat intelligence.

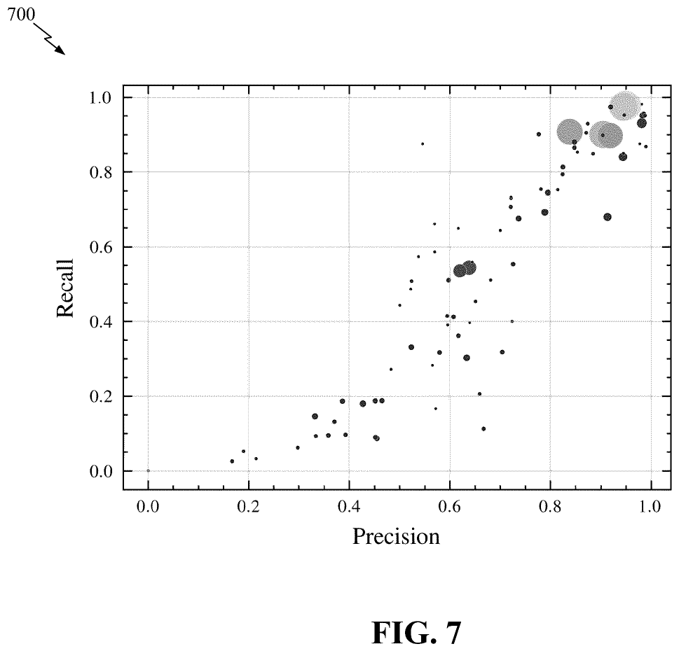

The performance of the various MLC methods applied on the coupled datasets shows that an association between the data collected at multiple sensors and this mapping can be effectively learned using machine learning approaches. As described above, the label imbalance and concurrence issues in the data can be handled and the prediction performance is not biased against any particular labels which can be seen from the bubble plot in FIG. 7, where both majority and minority labels are equally likely to be accurately predicted given that darknet captures sufficient information to characterize them.

On average, darknet observes an IP 1.31 days earlier than honeypot. This relative latency of more than a day is extremely valuable from security perspective where any form of early threat acknowledgement can save organizations from severe attacks, protecting them from incurring irreparable losses from sudden attacks. Darknets observe close to 10 million unique IPs in a month, which is about 5 times the number of distinct IPs that are lured by honeypots. Out of these 10 million IPs, around 8.5 million (about 85%) of the IPs are observed only by darknet and not observed by honeypot at all, which is a huge fraction considering that these are abundantly compromised malicious hosts.

On the other hand, among the 2 million IPs that are exposed to honeypot each month, half a million IPs are not observed by darknet (i.e. about 75%). This clearly presents an edge that large darknets can provide enhanced threat intelligence. Additionally, darknets can observe low-intensity scanners that would otherwise remain unobserved by smaller sensors, which means darknet can capture a comprehensive set of malicious hosts.

As such, amplifying threat understanding to a myriad of IPs globally leveraging the vast observability of darknet may provide cybersecurity professionals to get a more accurate picture of the current threat landscape. Thus, by integrating these data sources, the macroscopic view of the attack trends from darknet and the microscopic view of the malicious activities in the wild from honeypot can be obtained.

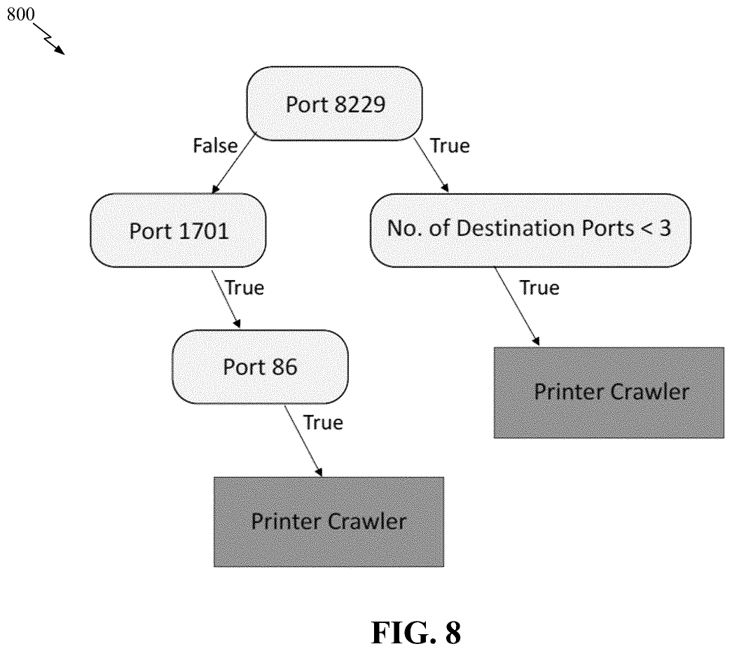

As mentioned above, the variation in the model's effectiveness across different group of labels can be evaluated through different case studies. In some examples, scanners and crawlers can be evaluated to determine the variation in the model's effectiveness across different group of labels. The scanners and crawlers can have a specific port scanning patterns along with other traffic features. As illustrated in FIG. 4, the classifier can predict scanner related labels with precision and recall. The decision trees built on the predictions of the classifier can provide interpretable explanations behind the classifier's performance on different labels. For example, an exemplar decision tree is shown in FIG. 8. FIG. 8 illustrates the darknet features that the classifier considers when predicting the “print crawler” label. Additionally, the tree shows that print crawlers can be identified by unique characteristic of scanning port. Accordingly optimal predictions outcomes on scanners can be associated with characteristic port scanning patterns.

In some examples, Mozi-related vulnerability exploits can be evaluated to determine the variation in the model's effectiveness across different group of labels. Mozi is a peer-to-peer (P2P) botnet that exploits unpatched IoT vulnerabilities and weak telnet passwords to infect devices. Referring back to FIG. 4, FIG. 4 illustrates the labels on which the classifier has poor prediction performance. Upon cross-verifying the IPs associated with this group of labels (e.g., GPON CVE-2018-10561 RouterWorm, Realtek MiniiGD, UPNP Worm CVE-2014-8361, EIR D1000 Router Worm) with the help of payloads, Mozi bots attempting to infect and propagate Mozi source code can be observed. Despite the specific IoT vulnerabilities that these Mozi bots are attempting to exploit, the goal of the Mozi bots is to infect more devices. Thus, the classifier is challenged by the absence of a generic Mozi (intent) related label and is poor in discriminating between these specific vulnerability exploits, which are almost indistinguishable in terms of associated traffic behavior and differ only in the content of payload.

In some examples, the classifier cannot achieve expected performance because of the limited information collected by darknet on account of its passive nature. For instance, the IPs associated with the label ‘Linksys E-Series TheMoon Worm’ scan an additional unique port “55555” in honeypot in addition to the ports scanned in darknet. Accordingly, the port is scanned after a connection has been established, which is why this port is not observed among the ports scanned in darknet. This unique port, 55555, may include an identifying characteristic of this label which is missing on the dataset on which the classifier is trained.

### Example—Learning Using Privileged Information

As described above, utilization of features derived from GreyNoise, which underpin the generation of threat intelligence labels, can significantly enhance the association learning. Although access to these features is limited to the training phase, the Learning Using Privileged Information (LUPI) paradigm enables the development of robust models by effectively leveraging this privileged information during training. This approach allows for the integration of additional context that can refine the learning process, thereby improving the accuracy and reliability of the resultant models. By harnessing the insights provided by GreyNoise features, the model can be trained to better discern patterns indicative of malicious activity, ultimately leading to more effective threat detection and attribution.

Privileged information in the context of machine learning refers to additional data that is accessible during the training phase but not available during the operational phase when the model is deployed. This concept is particularly beneficial in cybersecurity applications, where such information is generally available, and it can significantly enhance model performance and robustness. The paradigm that exemplifies how privileged information can be effectively utilized in machine learning is LUPI.

Learning Using Privileged Information, or LUPI, represents a paradigm in machine learning wherein privileged information is supplied to the learner by a teacher, in addition to the standard training data. This PI is only available for the training examples and is never available for the test examples. The goal of LUPI is to transfer knowledge from the space of privileged information to the space where the decision rule is constructed. This transfer can be achieved through knowledge distillation or marginalization with weight sharing. LUPI can help to accelerate the convergence rate of learning, especially when the learning problem is hard.

A machine learning model is being trained to classify images of different types of cars-a dataset of car images is not very large, and the images are quite similar. This makes it difficult for the model to learn to distinguish between the different car types. However, one can also access to a set of expert annotations for each image, which describe the key features of each car. This expert information is considered PI because it's not available at test time. LUPI can be used to leverage this privileged information to improve the model's performance. The model can be trained to learn from both the images and the expert annotations and then use this knowledge to classify new images. This approach can affect the model's accuracy, especially when the training data is limited.

The classical paradigm of machine learning can be formally articulated as follows: Consider a set of independent and identically distributed (iid) pairs, i.e. the training data, (x₁, y₁), . . . , ( [symbol] , [symbol] ), xᵢ∈X, yᵢ∈{−1, +1}, which are generated according to a fixed but unknown probability measure P(x, y). The objective is to identify a function ƒ(x, α*), from a specified set of indicator functions ƒ(x, α), where α∈Λ, that minimizes the probability of incorrect classifications (i.e., incorrect values of y∈{−1, +1}.

In this framework, each vector xᵢ∈X represents an example, following an unknown generator P(x) for random vectors xᵢ. Correspondingly, yᵢ∈{−1, +1} denotes its classification, defined by the conditional probability P(y|x). The primary aim of the learning machine is to determine the function y=ƒ(x, α*) that ensures the lowest probability of misclassification.

Thus, the goal is to minimize the risk functional

$$R ( α ) = \frac{1}{2} \int \vert y - f ( x , α ) \vert dP ( x , y )$$

over the set of indicator functions ƒ(x, α), with α∈Λ, in situations where the probability measure P(x, y)=P(y|x)P(x) remains unknown, but the training data is provided.

The LUPI paradigm introduces a more intricate model and eliminates the need for symmetric features in training and runtime, allowing the inclusion of ancillary information in training: Consider a collection of independent and identically distributed (iid) triplets (x₁, x₁, y₁), . . . , ( [symbol] , [symbol] , [symbol] ), xᵢ∈X, xᵢ*∈X*, yᵢ∈{−1, +1}, which are generated according to a fixed but unknown probability measure P(x, x*, y). The aim is to identify, from a designated set of indicator functions ƒ(x, α) with α∈Λ, the function y=ƒ(x, α*) that minimizes the probability of incorrect classifications.

In the context of the LUPI paradigm, the goal remains consistent with that of the classical approach: to minimize the probability of misclassification by finding the optimal classification function within the permissible set. However, during the training phase, a richer set of information is available; specifically, triplets (x, x*, y) are employed instead of the pairs (x, y) utilized in the classical framework. The additional data x*∈X* is derived from a space X*, which is, in general, different from X. For each training example (xᵢ, yᵢ), the Intelligent Teacher generates the privileged information xᵢ* using some unknown conditional probability function P(xᵢ*|xᵢ).

The LUPI framework extends the capabilities of Support Vector Machines (SVM) by utilizing PI to estimate slack values. The foundational concept of this initial formulation, known as SVM+, involves learning an SVM within a privileged space and determining the margin relative to this SVM for each training example. Training examples that are positioned closer to the margin are categorized as “more difficult,” while those positioned further away are deemed “less difficult.” Since the introduction of the new learning paradigm and the corresponding SVM+approach, there is a growing body of work on learning with privileged information. This framework has found application across a range of challenges, including ranking, clustering, metric learning, and computer vision. Moreover, privileged information is equivalent to weights assigned to each training example.

In the realm of cybersecurity, machine learning based detection/classification systems compares the runtime information against the known normal or anomalous states. This traditional approach relies solely on the features that are available at the runtime. In practice, many features are too expensive to collect in real-time or may be infeasible or undesirable to collect at runtime. This is a common scenario in cybersecurity where thorough analysis can generate multiple information but all these information cannot be used to build a model as they would simply be unavailable during deployment. It is observed that privileged information increased precision and recall, and relatively decreased malware detection error over a system with no privileged information.

Numerous applications illustrate a beneficial impact of privileged information (PI) on accuracy within the LUPI framework. However, this contribution may turn negative if the PI is noisy or redundant. Also, it is more damaging if the model becomes over reliant on the privileged information.

Given the training data T={(xᵢ, xᵢ*, Yᵢ)|i=1, . . . , n}, where x represents the available information, x* represents the privileged information, Y represents the target labels, and n represents the number of training instances. Y={yₖ∈{−1,1}|k=1, . . . , q} indicates the multiple labels, where q represents the number of labels.

The objective of LUPI for multi-label classification is to map the available information of an instance to its multiple labels with the help of privileged information and the label dependencies embedded in Y. Therefore, the objective function of LUPI for multi-label classification is defined as: minL=Σᵢ₌₁ⁿ( [symbol] (xᵢ, Yᵢ)+ [symbol] * (xᵢ*, Yᵢ))+C Σᵢ₌₁ⁿt(xᵢ, Yᵢ)+C* Σᵢ₌₁ⁿ t*(xᵢ*, Yᵢ)+D Σᵢ₌₁ⁿ p(xᵢ, xᵢ*, Yᵢ) where the terms [symbol] (xᵢ, Yᵢ) and [symbol] * (xᵢ*, Yᵢ) represent the loss functions of the available information classifier and the privileged information classifier, respectively. The functions t(xᵢ, Yᵢ) and t*(xᵢ*, Yᵢ) capture the dependencies among multiple labels, while p(xᵢ, xᵢ*, Yᵢ) reflects the constraints imposed by privileged information. The constants C, C*, and D are the weighted parameters.

This framework represents the general approach of LUPI for multi-label classification. As described herein, the decision will be made to follow established practices by adopting the maximum margin classifier as the loss function. Furthermore, the similarity between the classifier derived from available information and that obtained from privileged information will be utilized as the constraints associated with privileged information. Additionally, the ranking order of the predicted labels will serve as constraints to effectively capture multi-label dependencies.

Honeypots serve as sophisticated decoys, dynamically configured to attract malicious actors and record their activities in real-time. By simulating vulnerable systems, these traps create an enticing environment that lures attackers, enabling researchers to observe and analyze their tactics, techniques, and procedures. This dynamic setup captures payloads from attacks, which help determine the malicious intent of the attackers.

Packet payloads are not always transmitted, particularly when a scanner is focused only on identifying open ports. GreyNoise captures packet payloads when they are available, providing valuable insights. In this research, the only privileged information utilized will be the request URL in the payload, as it is sufficient to predict the labels where the multi-label classifier faced difficulties in the previous chapter. This request URL serves as a usable form of privileged information, as it can also be predicted using solely the darknet port features.

The ports scanned by GreyNoise represent another form of potential privileged information (PI). However, experiments from the previous chapter indicate that the value of the GreyNoise ports is minimal compared to the request URL within the payload. Consequently, including ports as privileged information is likely to contribute negatively, rather than positively, due to their redundancy.

The request URLs were systematically organized based on their shared prefixes, allowing for a structured grouping that enhances the model's ability to recognize patterns. This process involved identifying common elements within the URLs, which facilitated the subsequent application of one-hot encoding. In this research, a total of 238 unique URLs were extracted from this process, each representing a specific request that could provide valuable insights into the attack patterns being analyzed. Once the URLs were encoded, they were utilized to train the extended Support Vector Machine (SVM+) model.

To evaluate the performance of the trained multi-label classifier, the same metrics described above were employed, ensuring consistency in assessment and comparison. The comparison of the results with the best model is shown in Table 13.

TABLE 13
Performance of classifier trained with PI over without PI.

| | Prec. | Rec. | F1 | Prec. | Rec. | F1 | Prec. | Rec. | F1 |
|---|---|---|---|---|---|---|---|---|---|
| Metrics | Mac. | Mac. | Mac. | Mic. | Mic. | Mic. | Wtd. | Wtd. | Wtd. |
| Extended | 0.88 | 0.87 | 0.87 | 0.85 | 0.87 | 0.86 | 0.84 | 0.83 | 0.83 |
| SVM+ | | | | | | | | | |
| MLWSE | 0.85 | 0.79 | 0.82 | 0.81 | 0.84 | 0.82 | 0.82 | 0.82 | 0.82 |

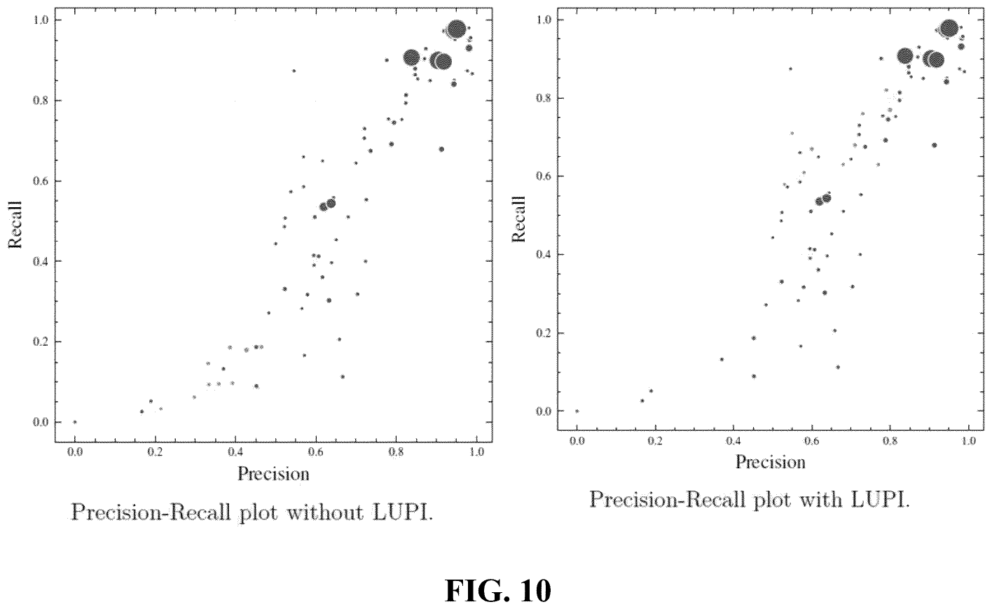

While the overall performance metrics of the model may not initially suggest dramatic improvements, a more granular analysis reveals notable advancements, especially concerning individual label predictions. This nuanced examination underscores the importance of diving deeper into the data rather than relying solely on aggregate statistics. Particularly striking is the enhancement in the classification of tags related to router exploits. These tags are linked to highly specific request URLs that encapsulate distinct patterns of malicious activity. Previously, the model's reliance on darknet features alone limited its ability to accurately identify these tags, leading to suboptimal performance. However, with the integration of privileged information, the request URL in the model has demonstrated significant gains in both precision and recall for these challenging labels. As illustrated in FIG. 10, the model's enhanced performance in recognizing router exploit tags not only indicates an improvement in accuracy but also reflects its capacity to discern complex patterns inherent in the attack data. This shift signals that the model can now effectively identify subtle distinctions among different types of malicious behavior, which were previously overlooked.

An intriguing observation from the analysis is that the inclusion of the request URL as privileged information (PI) significantly enhanced the model's performance for certain labels, particularly those associated with router exploits and other similarly targeted categories. This improvement, however, was not universally applicable across all labels.

The labels that exhibited gains in precision and recall are those for which the request URLs provided clear and distinguishable characteristics within the payload data. As demonstrated in Table 14, it becomes evident that the specificity and clarity of the request URLs played a crucial role in the model's ability to accurately classify these particular tags. For instance, router exploit labels are often tied to very specific request patterns that reflect distinct attack methodologies, allowing the model to leverage this information effectively. Conversely, labels lacking such clear and distinctive request URLs did not experience the same level of improvement. This disparity suggests that the effectiveness of privileged information is contingent upon its relevance and applicability to the specific context of the labels being predicted.

TABLE 14
Mapping - Router Exploit Labels, Request URL, Port.

| Label | Request URL | Port |
|---|---|---|
| Huawei H532 | /ctrlt/DeviceUpgrade_1 | 37215 |
| UPnP CVE | | |
| Realtek Miniigd | /picsdesc.xml | 52869 |
| UPnP CVE | | |
| NETGEAR DGN | /setup.cgi | 8443 |
| Command Execution | | |

### Example Implementations

Intrusion detection. In some implementations, the techniques described above (including, e.g., temporal change detection) can be implemented so as to provide an early warning system to enterprises of possible intrusions. While prevention of malware attacks is important, detection of malware scanning and intrusion into an enterprise is a critical aspect of cybersecurity. Therefore, a monitoring system following the principles described herein can be implemented, which can monitor scanning behavior of malware and what malware is doing. If a monitoring system detects that a new cluster is being revealed, the system can: identify primary sources (e.g., IP addresses) of the new scanning activity and make determinations of possible origin of the malware. Where sources of the new scanning activity are originating from a common enterprise, the system can immediately alert the operators of the enterprise that there are newly-compromised devices in their network. And, the system can alert the owners of the behavior of the compromised devices which can provide opportunities to mitigate penetration of the malware and improve security for future attacks.

In other instances, the monitoring software may detect new clusters forming and alert cybersecurity management organizations or cyber-insurance providers whenever one of their customers appears to have experienced an intrusion or owns an IP address being spoofed.

Early cyberattack signals. In addition to detection of intrusions that may have already occurred, other embodiments may also provide early signals that an attack may be imminent. For example, systems operating per the principles identified above may monitor Darknet activity and create clusters. Using change detection principles, new types of activities can be identified early (via, e.g., detection of newly-forming clusters, or activity that has the potential to form its own cluster). Thus, if attacker launches a significant new attack, and the system sees increased activity or new types of activities (e.g., changes that might signal a new attack) the system can flag these as critical changes.

Importantly, these increased activities may not themselves be the actual attack, but rather a prelude or preparation for a future attack. In some DDOS attacks, for example, attackers first scan the Internet for vulnerable servers that can be compromised and recruited for a future DDOS attack which will occur a few days later. Using the principles described above, increased scanning activity that exhibits characteristics of server compromise can be detected and/or the actual compromise of servers that could be utilized for a DDOS attack can be detected. Then, in the hours/days prior to the actual amplified attack, customers of the system may be able to employ a patch or update to quickly mitigate danger of a DDOS attack, or the owners of the compromised servers could take preventative action to remove malware from their systems and/or prevent scanning behavior.

In instances where attacks may be imminent, the system could recommend to its customers that they temporarily block certain channels/ports likely to be involved in the attack, if doing so would incur minimal interference to the business/network, to allow more time to remove the malware and/or install updates/patches.

Descriptive Alerts. In some embodiments, alerts provided to subscribers or other users can provide higher level characterizations of clusters of Darknet behavior that may help them take mitigating action. For example, clustering of certain Darknet activity may help a user understand that an attacker might be spoofing IP addresses, as opposed to an actual device at that IP address being compromised. Similarly, temporal change detection could be applied to various subdomains or within enterprises known to belong to certain categories (e.g., defense, retail, financial sectors, etc.).

In other embodiments, a scoring or ranking of the importance of an alert could be provided. For example, a larger cluster may mean that a given vulnerability is being exploited on a larger scale, or scores could be based on known IP addresses or the amount of traffic per IP (how aggressive). Rate of infection and rate of change of a cluster could also assist a user in determining how much a new attack campaign is growing. Relatedly, the port that is being scanned can give some information on function of the malware behind the scanning.

The above systems and methods have been described in terms of one or more preferred embodiments, but it is to be understood that other combinations of features and steps may also be utilized to achieve the advantages described herein. In some embodiments, any suitable computer readable media can be used for storing instructions for performing the functions and/or processes described herein. For example, in some aspects of the disclosure, computer readable media can be transitory or non-transitory. For example, non-transitory computer readable media can include media such as magnetic media (such as hard disks, etc.), optical media (such as compact discs, digital video discs, Blu-ray discs, etc.), semiconductor or solid state media (such as RAM, Flash memory, electrically programmable read only memory (EPROM), electrically erasable programmable read only memory (EEPROM), etc.), cloud-based remote storage, and any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term ‘system’ can encompass hardware, software, firmware, or any suitable combination thereof.

It should be understood that steps of processes described above can be executed or performed in any suitable order or sequence not limited to the order and sequence shown and described in the figures. Also, some of the above steps of the can be executed or performed substantially simultaneously where appropriate or in parallel to reduce latency and processing times.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for network scanning activity detection, comprising:
obtaining darknet data from darknet monitoring sensors;
applying the darknet data to a trained machine learning model;
obtaining one or more labels of honeypot data corresponding to the darknet data based on the trained machine learning model; and
providing a result of threat behaviors of internet protocols based on the one or more labels.

2. The method of claim 1, wherein the darknet data comprises network-based information.

3. The method of claim 2, wherein the network-based features comprise at least one of: a volume of scanning, an intensity indication of scanning, a size of exchanged bytes and packets, or scanned sets of ports.

4. The method of claim 1, wherein the one or more labels comprises payload-based information.

5. The method of claim 4, wherein the payload-based information comprises at least one of: a scan label set, an exploit label set, a malware label set, a brute-force label set, or a tool label set.

6. The method of claim 1, wherein the trained machine learning model comprises a multi-label classification machine learning model.

7. The method of claim 6, wherein the multi-label classification machine learning model comprises a stacked ensemble of a classifier chains model, a binary relevance classifier model, and a label powerset classifier model.

8. The method of claim 7, wherein the stacked ensemble is constructed with sparsity regularization.

9. A method for network scanning activity detection training, comprising:
obtaining training darknet data from darknet monitoring sensors;
obtaining ground-truth honeypot data;
integrating the training darknet data with labels of the ground-truth honeypot data; and
training a machine learning model based on the training darknet data and the labels of the ground-truth honeypot data, the labels corresponding to the training darknet data.

10. The method of claim 9, further comprising:
generating synthetic darknet data for a subset of the labels, a subset of training darknet data corresponding to the subset of the labels being less than another subset of training darknet data corresponding to another subset of the labels,
wherein training the machine learning model is further based on the synthetic darknet data.

11. The method of claim 10, wherein the synthetic darknet data is generated based on interpolation between neighboring instances in the subset of the training darknet data.

12. The method of claim 9, further comprising:
obtaining a plurality of annotations corresponding to a portion of the darknet data,
wherein the labels are integrated based on the plurality of annotations.

13. The method of claim 12, wherein the plurality of annotations corresponds to privileged information.

14. The method of claim 13, wherein the privileged information was obtained after the training darknet data was obtained from the darknet monitoring sensors.

15. A system for network scanning activity detection, the system comprising:
a darknet monitoring sensor;
a trained machine learning model;
a processor;
a memory having stored thereon a set of instructions which, when executed by the processor, cause the system to:
obtain, via the darknet monitoring sensor, darknet data;
apply the darknet data to the trained machine learning model;
obtain one or more labels of honeypot data corresponding to the darknet data based on the trained machine learning model;
output a result of threat behaviors of internet protocols based on the one or more labels.

16. The system of claim 15, wherein the one or more labels comprises payload-based information.

17. The system of claim 16, wherein the payload-based information comprises at least one of: a scan label set, an exploit label set, a malware label set, a brute-force label set, or a tool label set.

18. The system of claim 15, wherein the trained machine learning model is a multi-label classification machine learning model.

19. The system of claim 18, wherein the multi-label classification machine learning model comprises:
a stacked ensemble of a classifier chains model;
a binary relevance classifier model; and
a label powerset classifier model.
